(19) United States
(12) Patent Application Publication
(10) Pub. No.: US 2024/0297288 A1
(43) Pub. Date: Sep. 5, 2024

(54) METHOD FOR PRODUCING POSITIVE ELECTRODE ACTIVE MATERIAL FOR NONAQUEOUS ELECTROLYTE SECONDARY BATTERY

(71) Applicant: NICHIA CORPORATION, Anan-shi (JP)

(72) Inventors: Kenta KAWAI, Tokushima-shi (JP); Katsuyuki KITANO, Anan-shi (JP)

(73) Assignee: NICHIA CORPORATION, Anan-shi (JP)

(21) Appl. No.: 18/593,778

(22) Filed: Mar. 1, 2024

(30) Foreign Application Priority Data
Mar. 2, 2023 (JP) 2023-032045

(51) Int. Cl. H01M 4/04; H01M 4/02; H01M 4/36; H01M 4/505; H01M 4/525

(52) U.S. Cl. CPC H01M 4/0416; H01M 4/0471; H01M 4/366; H01M 4/505; H01M 4/525; H01M 2004/028

(57) ABSTRACT

A method for producing a positive electrode active material for a non-aqueous electrolyte secondary battery, the method comprising: preparing first particles each comprising a lithium transition metal composite oxide containing lithium and nickel and having a layered structure; contacting the first particles with a cobalt compound to obtain a cobalt adhering material; heat-treating the cobalt adhering material at a temperature in a range of 500° C. to 900° C. to obtain second particles; contacting the second particles with a liquid medium to obtain a liquid medium processed material; and contacting the liquid medium processed material with a boron compound to obtain a boron adhering material.

### CROSS-REFERENCE TO RELATED APPLICATIONS

This application claims priority to Japanese Patent Application No. 2023-032045, filed on Mar. 2, 2023, the disclosure of which is hereby incorporated by reference in its entirety.

### BACKGROUND

### Field of the Invention

The present disclosure relates to a method for producing positive electrode active material for non-aqueous electrolyte secondary battery.

### Description of the Related Art

A lithium transition metal composite oxide having a layered structure such as lithium cobalt oxide or lithium nickel oxide enables a high working voltage and acquisition of a large capacity, and is therefore widely used in electric power sources of electronic devices such as a mobile phone, a notebook-sized computer, and a digital camera and in on-vehicle batteries Along with the advancement of the functions of the electronic devices and the on-vehicle batteries, improvement of each of the safety, the output power property, and the like is demanded in addition to a further increase of the capacity and improvement of the charge-discharge cycle property.

In relation to the above, a technique has been proposed, of surface-coating a lithium transition metal composite oxide that includes nickel at a high density, with cobalt and boron (see, e.g., JP-T-2021-508154 and JP-T-2021-508161).

### SUMMARY

An object of an aspect of the present disclosure is to provide a production method for a positive electrode active material capable of improving the output power property maintaining the charge-discharge capacity in a non-aqueous electrolyte secondary battery.

A first aspect is a method for producing a positive electrode active material for a non-aqueous electrolyte secondary battery. The method includes preparing first particles each including a lithium transition metal composite oxide having a layered structure and including lithium and nickel, contacting the first particles with a cobalt compound to obtain a cobalt adhering material, heat-treating the cobalt adhering material at a temperature that is 500° C. or higher and 900° C. or lower to obtain second particles, contacting the second particles with a liquid medium to obtain a liquid medium processed material, and contacting the liquid medium processed material with a boron compound to obtain a boron adhering material.

According to an aspect of the present disclosure, a method for producing a positive electrode active material capable of improving the output power property maintaining the charge-discharge capacity in a non-aqueous electrolyte secondary battery may be provided.

The term “step” as used herein encompasses not only an independent step but also a step in which the anticipated effect of this step is achieved, even if the step cannot be clearly distinguished from another step. Unless specifically indicated, in a case in which each ingredient of a composition includes plural materials, the content of each ingredient of the composition denotes the total amount of the plural materials included in the composition. Further, upper limit and lower limit values that are described for a numerical range in the present specification can be arbitrarily selected and combined. Embodiments of the present invention will now be described in detail. The embodiments described below are exemplifications of a method for producing a positive electrode active material for a non-aqueous electrolyte secondary battery for embodying the technical ideas of the present invention, and the present invention is not limited to the method for producing the positive electrode active material for a non-aqueous electrolyte secondary battery described below.

### Method for Producing Positive Electrode Active Material for Non-Aqueous Electrolyte Secondary Battery

A method for producing a positive electrode active material for a non-aqueous electrolyte secondary battery (hereinafter, also referred to simply as “positive electrode active material”) includes a providing step of providing first particles each including a lithium transition metal composite oxide that has a layered structure and that includes lithium and nickel, a first adhesion step of contacting the first particles with a cobalt compound to obtain a cobalt adhering material, a first heat treatment step of heat-treating the cobalt adhering material at a temperature that is 500° C. or higher and 900° C. or lower to obtain second particles, a liquid medium processing step of contacting the second particles with a liquid medium to obtain a liquid medium processed material, and a second adhesion step of contacting the liquid medium processed material with a boron compound to obtain a boron adhering material. The method for producing a positive electrode active material may further include a second heat treatment step of heat-treating the boron adhering material to obtain a heat treated material. The positive electrode active material may include the boron adhering material or may include the heat treated material of the boron adhering material.

The compound including cobalt is caused to adhere to the surface of the lithium transition metal composite oxide to be thereafter processed using the liquid medium, the compound including boron is further caused to adhere thereto, and the output power property may be improved and the charge-discharge capacity in a non-aqueous electrolyte secondary battery may be maintained. This may be considered, for example, as follows. The output power property, especially, the output power property in a low-charge state (low-SOC) may be improved by causing the compound including cobalt to adhere. Any increase of nickel disorder may be suppressed and the output power property in the low-SOC may be improved maintaining the charge-discharge capacity to be large, by causing the compound including boron to adhere after further processing using the liquid medium.

### Providing Step

In the providing step, the first particles each including the lithium transition metal composite oxide that has a layered structure and that includes lithium and nickel are provided. The lithium transition metal composite oxide included in each of the first particles (hereinafter, also referred to as “first lithium transition metal composite oxide”) may include at least transition metals such as lithium (Li) and nickel (Ni), and may further include cobalt (Co). The first lithium transition metal composite oxide may further include a first metal element that includes at least one selected from the group consisting of further aluminum (Al), and manganese (Mn), includes lithium (Li), nickel (Ni), and cobalt (Co), and may further include at least one selected from the group consisting of aluminum (Al) and manganese (Mn).

In addition to the above, the first lithium transition metal composite oxide may further include a second metal element that includes at least one selected from the group consisting of calcium (Ca), zirconium (Zr), titanium (Ti), magnesium (Mg), tantalum (Ta), niobium (Nb), chromium (Cr), molybdenum (Mo), tungsten (W), iron (Fe), copper (Cu), silicon (Si), tin (Sn), bismuth (Bi), gallium (Ga), yttrium (Y), samarium (Sa), erbium (Er), cerium (Ce), neodymium (Nd), lanthanum (La), cadmium (Cd), and lutetium (Lu). The second metal element may also be at least one selected from the group consisting of zirconium (Zr), titanium (Ti), magnesium (Mg), tantalum (Ta), niobium (Nb), molybdenum (Mo), and tungsten (W)

The first lithium transition metal composite oxide may include nickel in its composition. In the case where the first lithium transition metal composite oxide includes nickel, the ratio of the number of moles of nickel to the total number of moles of the metal elements other than lithium may be, for example, greater than 0 and smaller than 1. The ratio of the number of moles of nickel to the total number of moles of the metal elements other than lithium may preferably be 0.33 or greater, 0.5 or greater, 0.6 or greater, 0.8 or greater, or 0.9 or greater. The ratio of the number of moles of nickel to the total number of moles of the metal elements other than lithium may preferably be 0.99 or smaller, 0.96 or smaller, 0.95 or smaller, or 0.94 or smaller. When the ratio of the number of moles of nickel is in the above ranges, the charge-discharge capacity and the durability that are more excellent tend to be easily established concurrently in the non-aqueous electrolyte secondary battery.

The first lithium transition metal composite oxide may further include cobalt in its composition. In the case where the first lithium transition metal composite oxide includes cobalt, the ratio of the number of moles of cobalt to the total number of moles of the metal elements other than lithium may be, for example, greater than 0 and smaller than 1, and may preferably be 0.005 or greater, 0.01 or greater, 0.015 or greater, or 0.018 or greater. The ratio of the number of moles of cobalt to the total number of moles of the metal elements other than lithium may preferably be 0.35 or smaller, 0.3 or smaller, 0.1 or smaller, 0.08 or smaller, 0.05 or smaller, or 0.03 or smaller. When the ratio of the number of moles of cobalt is in the above ranges, a battery and its properties that are more excellent may be established reducing the cost in the non-aqueous electrolyte secondary battery.

The first lithium transition metal composite oxide may further include, in its composition, the first metal element that includes at least one selected from the group consisting of aluminum and manganese. In the case where the first lithium transition metal composite oxide includes the first metal element, the ratio of the total number of moles of the first metal element to the total number of moles of the metal elements other than lithium may be, for example, greater than 0 and smaller than 1, and may preferably be 0.01 or greater, 0.02 or greater, or 0.03 or greater. The ratio of the total number of moles of the first metal element to the total number of moles of the metal elements other than lithium may preferably be 0.6 or smaller, 0.35 or smaller, 0.2 or smaller, 0.1 or smaller, 0.08 or smaller, 0.05 or smaller, or 0.04 or smaller. When the ratio of the total number of moles of the first metal element is in the above ranges, concurrent establishment of both of the charge-discharge capacity and the safety may be achieved in the non-aqueous electrolyte secondary battery.

The first lithium transition metal composite oxide may include, in its composition, both of aluminum and manganese as the first metal element. In the case where the first lithium transition metal composite oxide includes aluminum and manganese in its composition, the molar ratio of aluminum to manganese in the composition (aluminum/manganese) may be, for example, 0.001 or greater and 40 or smaller, and may preferably be 0.03 or greater, or 10 or smaller.

The first lithium transition metal composite oxide may further include, in its composition, the second metal element that includes at least one selected from the group consisting of calcium, zirconium, titanium, magnesium, tantalum, niobium, chromium, molybdenum, tungsten, iron, copper, silicon, tin, bismuth, gallium, yttrium, samarium, erbium, cerium, neodymium, lanthanum, cadmium, and lutetium. In the case where the first lithium transition metal composite oxide includes the second metal element, the ratio of the total number of moles of the second metal element to the total number of moles of the metal elements other than lithium may be, for example, greater than 0 and 0.05 or smaller, and may preferably be 0.001 or greater, 0.003 or greater, or 0.01 or greater. The ratio of the total number of moles of the second metal element to the total number of moles of the metal elements other than lithium may preferably be 0.04 or smaller, 0.03 or smaller, or 0.02 or smaller. When the ratio of the total number of moles of the second metal element is in the above ranges, concurrent establishment of both of a charge-discharge capacity and the safety that are excellent may be achieved in the non-aqueous electrolyte secondary battery.

The ratio of the number of moles of lithium to the total number of moles of the metals other than lithium in the first lithium transition metal composite oxide may be, for example, 0.95 or greater and may preferably be 1.0 or greater, 1.01 or greater, or 1.02 or greater. The ratio of the number of moles of lithium to the total number of moles of the metals other than lithium therein may be, for example, 1.5 or smaller, and may preferably be 1.3 or smaller, 1.2 or smaller, 1.1 or smaller, or 1.08 or smaller. When the ratio of the number of moles of lithium is 0.95 or greater, the interfacial resistance generated at the interface between the positive electrode surface and the non-aqueous electrolyte is suppressed in the non-aqueous electrolyte secondary battery that uses the positive electrode active material including the obtained lithium transition metal composite oxide, and the output power of the non-aqueous electrolyte secondary battery therefore tends to be improved. On the other hand, when the ratio of the number of moles of lithium is 1.5 or smaller, the initial discharge capacity tends to be improved in the case where the positive electrode active material is used in the positive electrode of the non-aqueous electrolyte secondary battery.

In the case where the first lithium transition metal composite oxide includes at least one selected from the group consisting of of manganese and aluminum in addition to nickel, the ratio of the number of moles of each of nickel and (manganese+aluminum) may be, for example, nickel:(manganese+aluminum)=(0.6 to 0.99):(0.01 to 0.4) and may preferably be (0.7 to 0.96):(0.04 to 0.3). In the case where the first lithium transition metal composite oxide includes cobalt, manganese, and aluminum in addition to nickel, the ratio of the number of moles of each of nickel, cobalt, and (manganese+aluminum) may be, for example, nickel:cobalt:(manganese+aluminum)=(0.33 to 0.99):(0.005 to 0.35):(0.005 to 0.6) and may preferably be (0.6 to 0.96):(0.01 to 0.1):(0.01 to 0.35).

When the first lithium transition metal composite oxide is represented as the composition, for example, a lithium transition metal composite oxide represented by Formula (1) can be listed. The first lithium transition metal composite oxide may be the one that has a layered structure and that has a crystal structure of a hexagonal system.

Li_{q}NiᵣCoₛM¹ₜM²ᵤO_{2+α} (1)
q, r, s, t, u, and a may satisfy 1.0≤q≤1.3, 0.33≤r≤1, 0≤s≤0.35, 0≤t≤0.6, 0≤u≤0.05, r+s+t+u=1, and −0.1≤α≤0.1. r, s, t, and u may satisfy 0.6≤r≤0.99, 0≤s≤0.3, 0≤t≤0.35, and 0≤u≤0.04, may satisfy 0.8≤r≤0.99, 0≤s≤0.1, 0≤t≤0.2, and 0≤u≤0.03, and may satisfy 0.9≤r≤0.96, 0.01≤s≤0.05, 0.02≤t≤0.08, and 0≤u≤0.02.

M¹ may represent at least one selected from the group consisting of Mn and Al. M² may represent at least one selected from the group consisting of Ca, Zr, Ti, Mg, Ta, Nb, Cr, Mo, W, Fe, Cu, Si, Sn, Bi, Ga, Y, Sm, Er, Ce, Nd, La, Cd, and Lu, and may represent at least one selected from the group consisting of Zr, Ti, Mg, Ta, Nb, Mo, and W.

The first lithium transition metal composite oxide may be secondary particles each formed by plural primary particles that are aggregated. The average particle diameter D_{SEM} of the primary particles based on an observation using an electron microscope is, for example, 0.1 μm or larger and 1.5 μm or smaller, and may preferably be 0.12 μm or larger or 0.15 μm or larger. The average particle diameter D_{SEM} of the primary particles based on an observation using an electron microscope may preferably be 1.2 μm or smaller or 1.0 μm or smaller. In the case where the average particle diameter of the primary particles based on an observation using an electron microscope is in the above ranges, the output power may be improved when the primary particles are included in a battery. The average particle diameter of the primary particles based on an observation using an electron microscope is measured as follows. The primary particles constituting the secondary particles are observed using a scanning electron microscope (SEM) with the magnifying power of 1,000 times to 15,000 times depending on the particle diameter. 50 primary particles whose contours are each recognizable are selected, their sphere equivalent diameters are calculated from the contours of the selected primary particles using image processing software, and the average particle diameter of the primary particles based on an observation using an electron microscope is obtained as the arithmetic average value of the obtained sphere equivalent diameters. In one aspect, the primary particles may each have particles that have the average particle diameter smaller than that of the primary particles, adhering to the surface thereof. In one aspect, the primary particles may each be an aggregation of particles that have an average particle diameter smaller than that of the primary particles. The average particle diameter of the above particles that have the average particle diameter smaller than that of the primary particles may be measured based on an observation using an electron microscope in the same manner as that of the above. The expression “the contours of the primary particles are recognizable” means that the overall contour of each of the primary particles can be traced in an image.

As to the secondary particles, the ratio of the 50% particle diameter D₅₀ in the cumulative particle size distribution on a volume basis to the average particle diameter D_{SEM} based on an observation using an electron microscope, D₅₀/D_{SEM}, may be, for example, 2.5 or greater. The ratio D₅₀/D_{SEM} is, for example, 2.5 or greater and 150 or smaller, and may preferably be 5 or greater, or 10 or greater. The ratio D₅₀/D_{SEM} may preferably be 100 or smaller, or 50 or smaller.

The first lithium transition metal composite oxide may be provided by purchasing or the like, or may be provided by producing using a known method. For example, the first lithium transition metal composite oxide may be prepared by mixing a lithium compound and composite oxide particles including nickel with each other and applying heat treatment to the obtained mixture. For example, the first lithium transition metal composite oxide may be produced using a production method that includes steps of obtaining a raw material mixture by mixing a lithium compound such as lithium hydroxide, and composite oxide particles having a desired composition with each other, and applying heat treatment to the obtained raw material mixture. For the production method for the composite oxide particles, description in each of, for example, JP2003-292322A, and JP2011-116580A (USP2012/270107) may be referred to.

### First Adhesion Step

In the first adhesion step, the provided first particles and a cobalt compound are brought into contact with each other to obtain a cobalt adhering material. The cobalt compound may be an oxide, a hydroxide, a salt, or the like that contains cobalt. Examples of the cobalt compound may include, for example, cobalt oxide, cobalt sulfate, cobalt nitrate, cobalt chloride, cobalt carbonate, and cobalt hydroxide. The cobalt compound may include at least one selected from the group consisting of cobalt oxide, cobalt sulfate, cobalt nitrate, cobalt chloride, and cobalt hydroxide. The cobalt compound may be one type alone or may be a combination of two or more types.

The contact of the first particles and the cobalt compound with each other may be performed using a dry method or a wet method, and may preferably be performed using the dry method. In the case where the contact is performed using the dry method, excessive elution of any alkaline component included in the first particles may be reduced and any increase of the nickel disorder may thereby be suppressed. In the case where the contact is performed using the dry method, the lithium transition metal composite oxide and the cobalt compound are mixed with each other using, for example, a high speed shear mixer or a mechano-fusion, and these materials may thereby be brought into contact with each other.

The total amount of the cobalt compound to be brought into contact with the first particles, as a ratio of the number of moles of cobalt atoms to the total number of moles of the metal atoms other than lithium in the first lithium transition metal composite oxide included in the first particles, may be, for example, 0.1 mole % or larger and 5.0 mole % or smaller, may preferably be 0.5 mole % or larger, or 1.0 mole % or larger, and may preferably be 10 mole % or smaller, or 5.0 mole % or smaller. When the total amount of the cobalt compound is in the above ranges, the output power property tends to be improvable.

The temperature for mixing the first particles and the cobalt compound with each other may be, for example, 5° C. or higher and 60° C. or lower, and may preferably be 15° C. or higher or 40° C. or lower. The time period of the mixing may be, for example, 1 minute or longer and 60 minutes or shorter, and may preferably be 2 minutes or longer, or 10 minutes or shorter.

### First Heat Treatment Step

In the first heat treatment step, heat treatment is applied to the cobalt adhering material obtained in the first adhesion step at a temperature that is 500° C. or higher and 900° C. or lower to obtain the second particles. In each of the obtained second particles, the density of cobalt in the vicinity of the surface of the lithium transition metal composite oxide particle may be higher than that in the vicinity of the center of the lithium transition metal composite oxide particle. The second particles may each have the adhering material that includes cobalt, on the surface of the lithium transition metal composite oxide particle. As to the second particles, the density of cobalt in the surface of at least some of the primary particles may be higher in the form for cobalt to solid-solve into the primary particles due to the adhesion of the cobalt compound and the heat treatment, and the density of cobalt at the grain boundaries of the primary particles may be high.

The temperature for the heat treatment in the first heat treatment step may preferably be 550° C. or higher, or 600° C. or higher, and may preferably be 850° C. or lower, or 800° C. or lower. The time period of the heat treatment may be, for example, 1 hour or longer and 20 hours or shorter, and may preferably be 3 hours or longer, or 15 hours or shorter. The atmosphere for the heat treatment may be, for example, an atmosphere including oxygen, or may be the atmospheric air.

To the second particles after applied the heat treatment process such as, crushing, pulverization, a particle size classification operation, and a granulation operation may be applied as necessary.

### Liquid Medium Processing Step

In the liquid medium processing step, the second particles are brought into contact with a liquid medium to obtain the liquid medium processed material. To the liquid medium processed material after undergoing the contact with the liquid medium, a dewatering process, a drying process, and the like may be applied as necessary. The liquid medium processing step may be, for example, a step of removing at least a portion of the alkaline component of the unreacted raw materials that are present in the second particles.

The liquid medium only has to include at least water, and may include a water-soluble organic solvent such as a lower alcohol as necessary in addition to water. In the case where the liquid medium includes the water-soluble organic solvent, the content of the water-soluble organic solvent may be, for example, 1 volume % or larger and 50 volume % or smaller, and may preferably be 20 volume % or smaller. The liquid medium may further include at least one alkali metal salt selected from the group consisting of a lithium salt, a sodium salt, and a potassium salt, and may include at least the sodium salt. Examples of anions forming the lithium salt, the sodium salt, or the potassium salt can include halide ions such as chloride ions, sulfate ions, nitrate ions, and hydroxide ions, and the liquid medium preferably include at least one selected from the group consisting of the above and more preferably include at least sulfate ions. In the case where the liquid medium includes at least one alkali metal salt selected from the group consisting of the lithium salt, the sodium salt, and the potassium salt, the content rate of the alkali metal ions in the liquid medium may be, for example, 0.01 mole/L or higher and 2.0 mole/L or lower, may preferably be 0.05 mole/L or higher, 0.1 mole/L or higher, 0.2 mole/L or higher, 0.3 mole/L or higher, or 0.4 mole/L or higher, and may preferably be 1.5 mole/L or lower, 1.0 mole/L or lower, 0.6 mole/L or lower, or 0.5 mole/L or lower.

The liquid medium may include other metal salts other than the lithium salt, the sodium salt, and the potassium salt as necessary. Examples of the metal ions included in the other metal salts can include, for example, alkali earth metal ions such as magnesium ions and potassium ions, and the like. In the case where a cleaning fluid includes the other metal ions, the content rate thereof may be, for example, 0.1 mole/L or lower and may preferably be lower than 0.01 mole/L.

The temperature for the contact of the second particles and the liquid medium with each other may be, for example, 5° C. or higher and 60° C. or lower, and may preferably be 10° C. or higher, or 40° C. or lower. The time period of the contact may be, for example, 1 minute or longer and 2 hours or shorter, and preferably is 10 minutes or longer, or 1 hour or shorter. The liquid amount of the liquid medium used for the contact, relative to the mass of the second particle, may be, for example, a 0.25-fold amount or larger and a 10-fold amount or smaller, and may preferably be a 0.5-fold amount or larger, or a 4-fold amount or smaller.

The contact of the second particles and the liquid medium with each other may be performed by adding the second particles into the liquid medium to prepare a slurry. In the case where the contact is performed as the slurry, the concentration of the solid component of the second particles in the slurry may be, for example, 10% by mass or higher and 80% by mass or lower, and may preferably be 20% by mass or higher, or 60% by mass or lower. The contact may be performed by causing the liquid medium to pass through the second particles that are held on a filter, or may be performed by washing the second particles with pure water or the like, and thereafter causing the liquid medium to pass through a dewatered cake obtained by dewatering the second particles. In the case where the second particles are washed with pure water or the like, and the liquid medium is thereafter caused to pass through the dewatered cake obtained by dewatering the second particles, the total liquid amount of the pure water and the liquid medium that are used is preferably a 0.25-fold amount or larger and a 10-fold amount or smaller, and is more preferably a 0.5-fold amount or larger and a 4-fold amount or smaller, relative to the mass of the second particles. The liquid medium including the alkali metal ions (such as, for example, a sodium sulfate solution) presents a solubility for residual alkali (such as, for example, lithium carbonate) that is higher than that of pure water, and is easy to remove the residual alkali therefrom. It is therefore preferred that the contact with the liquid medium be prioritized, from the viewpoint of reduction of damage to the lithium transition metal composite oxide. It is also preferred that no washing with pure water be performed.

The liquid medium processed material obtained in the liquid medium processing step may include a compound that includes an alkali metal such as sodium, in addition to the lithium transition meal composite oxide. The compound including an alkali metal may be present, for example, in the grain boundary of each of the secondary particles each including the primary particles each including the lithium transition metal composite oxide. The content rate of the compound including an alkali metal, that is included in the liquid medium processed material, as converted into the alkali metal elements, may be, for example, 100 ppm or higher and 1,400 ppm or lower, may preferably be 150 ppm or higher, 200 ppm or higher, or 300 ppm or higher, and may preferably be 1,300 ppm or lower, 1,200 ppm or lower, or 1,000 ppm or lower. When the content rate of the compound including an alkali metal is in the above ranges, the resistance component during each of the charging and the discharging tends to sufficiently be reduced. The content rate of the compound including an alkali metal in the liquid medium processed material may be adjusted using, for example, the concentration of the alkali metal ions of the liquid medium or the amount of water adhering to the dewatered cake.

The liquid medium processed material obtained in the liquid medium processing step may undergo a drying process. The drying process only has to remove at least a portion of the water adhering to the liquid medium processed material, and may be performed by drying by heating, air drying, reduced-pressure drying, or the like. The temperature for the drying in the case of drying by heating only has to be a temperature at which the water included in the liquid medium processed material is sufficiently removed. The temperature for the drying is, for example, 80° C. or higher and 300° C. or lower, and is preferably 100° C. or higher and 250° C. or lower. When the temperature for the drying is in the above ranges, elution of the lithium ions into the adhering water may sufficiently be suppressed. Disintegration of the crystal structure in the surface of each of the particles may also be suppressed and any reduction of the charge-discharge capacity may sufficiently be suppressed. The time period of the drying only has to be selected as necessary depending on the amount of the water included in the liquid medium processed material. The time period of the drying is, for example, 1 hour or longer and 10 hours or shorter. The amount of water included in the liquid medium processed material after the drying process is, for example, 0.2% by mass or smaller, and is preferably 0.1% by mass or smaller.

The degree of the washing in the liquid medium processing step may be checked using the content of lithium in the liquid medium processed material, the residual alkaline component, the specific surface area, or the like. In general, when the specific surface area of the liquid medium processed material is small, cracking of the particles, elution of lithium and the elements constituting the composite oxide, and the like may sufficiently be suppressed and the cycle property tends to be more improved. The residual alkaline component may sufficiently be reduced by setting the specific surface area to have a specific degree of magnitude. A water solution of a sodium salt such as sodium sulfate as the liquid medium presents a solubility for a lithium salt that is higher compared to that of pure water, a lithium salt water solution, and the like, and the liquid amount necessary for removing the alkali may therefore be reduced. As a result, the specific surface area of the liquid medium processed material is reduced and any excessive elution of lithium from the liquid medium processed material may be suppressed.

### Second Adhesion Step

In the second adhesion step, the liquid medium processed material and a boron compound are brought into contact with each other to obtain a boron adhering material. The contact of the liquid medium processed material and the boron compound with each other may be performed by dry mixing or wet mixing. The dry mixing may be performed using, for example, a super-mixer or a double-cone mixer. In the second adhesion step, an elemental substance, an alloy, or a metal compound of another metal element may be caused to adhere, In addition to the boron compound. Examples of the other metal element include, for example, Al, Si, Zr, Ti, Mg, Ta, Nb, Mo, and W, and the other metal element may include at least one selected from the group consisting of the above.

The boron compound may be selected from at least one selected from the group consisting of boron oxide, oxo acid of boron, and oxo acid salt of boron. More specific examples of the boron compound include orthoboric acid (H₃BO₃: that is the what-is-called ordinary boric acid), lithium tetraborate (Li₂B₄O₇), ammonium pentaborate (NH₄B₅O₈), lithium metaborate (LiBO₂), boron oxide (B₂O₃), and the like, and the boron compound preferably includes at least one selected from the group consisting of the above and may include at least orthoboric acid. One type of the boron compound may be used alone, or two or more types thereof may be used in combination.

The boron compound may be brought into contact, in its solid condition, with the liquid medium processed material by mixing therewith or may be brought into contact, as a solution of the boron compound, with the liquid medium processed material. It is preferred that the boron compound be brought into contact, in its solid condition, with the liquid medium processed material, due to the point that the surface condition of the boron adhering material obtained after being brought into contact with the boron compound may be made excellent. In the case where the boron compound in its solid condition is used, the volume average particle diameter of the boron compound may be, for example, 1 μm or larger and 60 μm or smaller, and may preferably be 10 μm or larger and 30 μm or smaller.

The contact amount of the boron compound in the second adhesion step, as a ratio of the number of moles of boron atoms to the total number of moles of the metals other than lithium in the lithium transition metal composite oxide, may be, for example, 0.05 mole % or higher and 2 mole % or lower, may be preferably 0.1 mole % or higher, more preferably 0.15 mole % or higher, and further preferably 0.2 mole % or higher, and may be preferably 1.5 mole % or lower, 1.2 mole % or lower, 0.9 mole % or lower, 0.8 mole % or lower, or 0.5 mole % or lower.

The method for producing a positive electrode active material for a non-aqueous electrolyte secondary battery may further include the second heat treatment step of applying heat treatment to the boron adhering material obtained in the second adhesion step at a temperature that is 100° C. or higher and 450° C. or lower to obtain the heat treated material. The charge-discharge capacity of the non-aqueous electrolyte secondary battery may be more improved by applying the heat treatment to the boron adhering material at a specific temperature.

The temperature for the heat treatment in the second heat treatment step may preferably be 200° C. or higher, 220° C. or higher, or 250° C. or higher, and may preferably be 400° C. or lower, or 350° C. or lower. The atmosphere for the heat treatment may be an atmosphere including oxygen or may be the atmospheric air. The time period of the heat treatment may be, for example, 1 hour or longer and 20 hours or shorter, and may be preferably 5 hours or longer, or 10 hours or shorter. A crushing process, a particle size classification process, and the like may be performed as necessary for the heat treated material obtained in the second heat treatment step.

A lithium defecting region may be formed in the vicinity of the surface of the liquid medium processed material after a liquid medium contact step and, in the lithium defecting region, desorption and insertion of lithium ions may be blocked. It may be considered that the lithium defect is compensated and the block of the desorption and the insertion of the lithium ions is suppressed to improve the charge-discharge property and the cycle property, by bringing the boron compound into contact with the liquid medium processed material after the liquid medium contact step to apply the heat treatment thereto. In the case where the secondary particles each formed by an aggregation of the primary particles are used as the first lithium transition metal composite oxide, the boron compound is more easily distributed also inside the secondary particles, that is, among the primary particles by bringing the boron compound into contact therewith after the liquid medium contact step. It may be considered that the effect of improving the properties by the boron compound is thereby more enhanced.

### Positive Electrode Active Material for Non-Aqueous Electrolyte Secondary Battery

The positive electrode active material may include the secondary particles each formed by an aggregation of plural primary particles each including the lithium transition metal composite oxide that has a layered structure and includes lithium, nickel, and cobalt (hereinafter, also referred to as “second lithium transition metal composite oxide”). As to each of the primary particles, the density of cobalt in the vicinity of the surface of the primary particle may be higher than that in the vicinity of the center of the primary particle. The lithium transition metal composite oxide has the disorder of nickel elements, that may be 3% or lower, and the secondary particles each have the adhering material that includes boron, in the surface thereof. The positive electrode active material may be the one that is produced using the production method for a positive electrode active material for a non-aqueous electrolyte secondary battery described above.

The ratio of the number of moles of nickel to the total number of moles of the metals other than lithium in the composition of the second lithium transition metal composite oxide constituting the primary particles may be 0.5 or greater and smaller than 1, may preferably be 0.7 or greater, 0.8 or greater, or 0.9 or greater, and may preferably be 0.95 or smaller. The charge-discharge property and the cycle property that are more excellent are achieved with the positive electrode active material including the lithium transition metal composite oxide whose ratio of the number of moles of nickel is great. The composition of the lithium transition metal composite oxide may be determined by, for example, an inductively coupled plasma atomic emission spectroscopy apparatus.

The second lithium transition metal composite oxide may include cobalt in its composition. In the second lithium transition metal composite oxide, the ratio of the number of moles of cobalt to the total number of moles of the metals other than lithium may be, for example, greater than 0 and 0.35 or smaller, and may preferably be 0.01 or greater, 0.015 or greater, or 0.02 or greater. The ratio of the number of moles of cobalt to the total number of moles of the metals other than lithium may be 0.2 or smaller, 0.15 or smaller, 0.1 or smaller, 0.05 or smaller, or 0.04 or smaller.

The second lithium transition metal composite oxide may include manganese in its composition. In the case where the second lithium transition metal composite oxide includes manganese, the ratio of the number of moles of manganese to the total number of moles of the metals other than lithium may be, for example, greater than 0 and smaller than 1, and may preferably be 0.01 or greater, or 0.35 or smaller. The second lithium transition metal composite oxide may include aluminum in its composition. In the case where the second lithium transition metal composite oxide includes aluminum, the ratio of the number of moles of aluminum to the total number of moles of the metals other than lithium may be, for example, greater than 0 and 0.2 or smaller, and may preferably be 0.01 or greater, or 0.05 or smaller, or 0.04 or smaller.

The second lithium transition metal composite oxide may include both of aluminum and manganese as the first metal element in its composition. In the case where the second lithium transition metal composite oxide includes aluminum and manganese in its composition, the molar ratio of aluminum to manganese in the composition (aluminum/manganese) may be, for example, 0.001 or greater and 40 or smaller and may preferably be 0.03 or greater, or 10 or smaller.

The second lithium transition metal composite oxide may further include, in its composition, the second metal element that includes at least one selected from the group consisting of calcium, zirconium, titanium, magnesium, tantalum, niobium, chromium, molybdenum, tungsten, iron, copper, silicon, tin, bismuth, gallium, yttrium, samarium, erbium, cerium, neodymium, lanthanum, cadmium, and lutetium. In the case where the second lithium transition metal composite oxide includes the second metal element, the ratio of the total number of moles of the second metal element to the total number of moles of the metal elements other than lithium may be, for example, greater than 0 and 0.05 or smaller, and may preferably be 0.001 or greater, 0.003 or greater, or 0.01 or greater. The ratio of the total number of moles of the second metal element to the total number of moles of the metal elements other than lithium may preferably be 0.04 or smaller, 0.03 or smaller, or 0.02 or smaller. When the ratio of the total number of moles of the second metal element is in the above ranges, establishment of both of the charge-discharge capacity and the safety may be achieved in the non-aqueous electrolyte secondary battery.

The ratio of the number of moles of lithium to the total number of moles of the metals other than lithium in the second lithium transition metal composite oxide may be, for example, 0.95 or greater, and may preferably be 1.0 or greater, 1.01 or greater, or 1.02 or greater. The ratio of the number of moles of lithium to the total number of moles of the metals other than lithium is, for example, 1.5 or smaller, and may preferably be 1.3 or smaller, 1.2 or smaller, 1.1 or smaller, or 1.08 or smaller. When the ratio of the number of moles of lithium is 0.95 or greater, the interfacial resistance generated at the interface between the surface of the positive electrode and the non-aqueous electrolyte may be suppressed in the non-aqueous electrolyte secondary battery that uses the obtained positive electrode active material, and the output power of the non-aqueous electrolyte secondary battery therefore tends to be improved. On the other hand, when the ratio of the number of moles of lithium is 1.5 or smaller, the initial discharge capacity tends to be improved in the case where the positive electrode active material is used in the positive electrode of the non-aqueous electrolyte secondary battery.

The second lithium transition metal composite oxide may have a composition represented by Formula (2) as below.

LiₚNiₓCo_{y}M¹_{z}M²_{w}O_{2+β} (2)

p, x, y, z, w, and β may satisfy 1.0≤p≤1.3, 0.33≤x≤1, 0≤y≤0.35, 0≤z≤0.6, 0≤w≤0.05, x+y+z+w=1, and −0.1≤β≤0.1. x, y, z, and w may satisfy 0.6≤x≤0.99, 0<y≤0.3, 0<z≤0.35, and 0≤w≤0.04, may satisfy 0.8≤x≤0.98, 0.01≤y≤0.2, 0<z≤0.15, and 0≤w≤0.03, and may satisfy 0.9≤x≤0.95, 0.01≤y≤0.05, 0.02≤z≤0.08, and 0≤w≤0.02.

M¹ may represent at least one selected from the group consisting of Mn and Al. M² may include at least one selected from the group consisting of Ca, Zr, Ti, Mg, Ta, Nb, Cr, Mo, W, Fe, Cu, Si, Sn, Bi, Ga, Y, Sm, Er, Ce, Nd, La, Cd, and Lu, and may include at least one selected from the group consisting of Zr, Ti, Mg, Ta, Nb, Mo, and W.

At least a portion of the surface of each of the primary particles may have a compound including boron, adhering thereto. Examples of the compound including boron can include, for example, lithium metaborate (LiBO₂). The compound including boron may form a composite, with the lithium transition metal composite oxide. The content of the compound including boron in the positive electrode active material, as a ratio of the number of moles of the boron element to the total number of moles of the metals other than lithium in the second lithium transition metal composite oxide, may be, for example, 0.05 mole % or higher and 2 mole % or lower, may preferably be 0.1 mole % or higher, 0.15 mole % or higher, or 0.2 mole % or higher, and may preferably be 1.5 mole % or lower, 1.2 mole % or lower, 0.9 mole % or lower, 0.8 mole % or lower, or 0.5 mole % or lower. The content of boron in the positive electrode active material may be determined by, for example, an inductively coupled plasma atomic emission spectroscopy apparatus.

The volume average particle diameter of the second particles may be, for example, 1 μm or larger and 30 μm or smaller, and may preferably be 3 μm or larger, 10 m or larger, or 12 μm or larger, and may preferably be 20 μm or smaller, 18 μm or smaller, or 16 μm or smaller. When the volume average particle diameter of the second particles is in the above ranges, excellent fluidity may be presented and, when the second particles are used in a secondary battery, the output power may be more improved. The volume average particle diameter is the 50% particle diameter D₅₀ that corresponds to the cumulative 50% from the small particle diameter side in the cumulative particle size distribution on a volume basis. The cumulative particle size distribution on a volume basis is measured using a laser diffraction particle size distribution measuring apparatus under a wet condition.

The second lithium transition metal composite oxide may be the secondary particles each formed by an aggregation of the plural primary particles. The average particle diameter D_{SEM} of the primary particles based on an observation using a scanning electron microscope is, for example, 0.1 μm or larger and 1.5 μm or smaller, may preferably be 0.12 μm or larger or 0.15 μm or larger. The average particle diameter D_{SEM} of the primary particles based on an observation using an electron microscope may preferably be 1.2 μm or smaller, or 1.0 μm or smaller. When the average particle diameter of the primary particles based on an observation using a scanning electron microscope is in the above ranges, the output power may be improved in the case where the primary particles are included in a battery. The average particle diameter of the primary particles based on an observation using a scanning electron microscope is measured as follows. The primary particles constituting the secondary particles are observed using a scanning electron microscope (SEM) with the magnifying power of 1,000 times to 15,000 times depending on the particle diameter. 50 primary particles whose contours are each recognizable are selected, their sphere equivalent diameters are calculated from the contours of the selected primary particles using image processing software, and the average particle diameter of the primary particles based on an observation using a scanning electron microscope is obtained as the arithmetic average value of the obtained sphere equivalent diameters. In one aspect, the primary particles may each have particles that have the average particle diameter smaller than that of the primary particles, adhering to the surface thereof. In one aspect, the primary particles may each be an aggregation of particles that have the average particle diameter smaller than that of the primary particles. The average particle diameter of the above particles that have the average particle diameter smaller than that of the primary particles may be measured based on an observation using a scanning electron microscope in the same manner as that of the above. The expression “the contours of the primary particles are recognizable” means that the overall contour of each of the primary particles can be traced in an image.

The secondary particles have the ratio of the 50% particle diameter D₅₀ in the cumulative particle size distribution on a volume basis to the average particle diameter D_{SEM} based on an observation using a scanning electron microscope, D₅₀/D_{SEM}, that may be, for example, 2.5 or greater. The ratio D₅₀/D_{SEM} is, for example, 2.5 or greater and 150 or smaller, and may preferably be 5 or greater, or 10 or greater. The ratio D₅₀/D_{SEM} may preferably be 100 or smaller, or 50 or smaller.

In each of the second particles included in the positive electrode active material, the density of cobalt in the vicinity of the surface of each of the primary particles may be higher than that in the vicinity of the center of the primary particle. In other words, the density of cobalt in the vicinity of the grain boundaries of the secondary particles may be higher compared to that in the inside of each of the primary particles. The distribution of cobalt in each of the secondary particles may be measured by, for example, observing the cross-section of the secondary particle using a TEM-EDX. The secondary particles may each have a first region whose depth from the surface of the particle is 150 nm, and a second region whose depth from the surface of the particle 10 nm or smaller. In each of the secondary particles, the ratio of the number of moles of cobalt to the total number of moles of the metals other than lithium may be greater in the second region than that in the first region. A desired positive electrode active material having the first region and the second region can be obtained by bringing the lithium transition metal composite oxide and the cobalt compound into contact with each other and applying heat treatment thereto, as described in the method for producing a positive electrode active material for a non-aqueous electrolyte secondary battery as above.

### Nickel Disorder

In the lithium transition metal composite oxide included in the positive electrode active material, disorder of nickel element determine using an X-ray diffraction method is preferably lower than 3%, more preferably 2% or lower, and further preferably 1.5% or lower. The disorder of nickel element means chemical arrangement disorder (chemical disorder) of transition metal ions (nickel ions) to occupy their original sites. In the lithium transition metal composite oxide having a layered structure, the typical one is an exchange of an alkali metal ion to occupy a site denoted by 3b in the case where the site is denoted by a Wyckoff symbol (“3b site”, similarly in the following) and a transition metal ion to occupy a 3a site. Smaller disorder of the nickel element presents a more improved initial efficiency and is therefore preferred.

The disorder of the nickel element in the lithium transition metal composite oxide may be determined using an X-ray diffraction method. An X-ray diffraction spectrum is measured for the lithium transition metal composite oxide using a CuKα radiation (with a tube current of 200 mA and a tube voltage of 45 kV). It is assumed that a composition model is (Li_{1-d}Ni_{d}) (NiₓCo_{y}Mn_{z}Al_{w}) O₂ (x+y+z+w=1), and structure optimization is performed using the Rietveld analysis that uses Rietan 2000 software based on the obtained X-ray diffraction spectrum. The percentage of d calculated as the result of the structure optimization is taken as the value of the disorder of the nickel element.

The volume average particle diameter of the positive electrode active material may be, for example, 1 μm or larger and 30 μm or smaller, may preferably be 5 μm or larger, 10 μm or larger, or 12 μm or larger, and may preferably be 20 μm or smaller, 18 m or smaller, or 16 μm or smaller. When the volume average particle diameter of the positive electrode active material is in the above ranges, both of the output power property and the density may be able to be achieved. The volume average particle diameter is a 50% particle diameter D₅₀ that corresponds to the cumulative 50% from the small particle diameter side in the cumulative particle size distribution on a volume basis.

The specific surface area of the positive electrode active material may be, for example, 0.4 m²/g or larger and 4 m²/g or smaller, may preferably be 0.45 m²/g or larger, or 0.6 m²/g or larger, and may preferably be 3.0 m²/g or smaller, 1.6 m²/g or smaller, or 1.4 m²/g or smaller. The specific surface area may be measured using a BET method.

### Alkaline Component

The positive electrode active material may include lithium hydroxide, lithium carbonate, or the like as an alkaline component. In the case where the positive electrode active material includes lithium hydroxide, the content of lithium hydroxide may be, for example, 0.01% by mass or larger and 1.0% by mass or smaller, may preferably be 0.01% by mass or larger, 0.05% by mass or larger, or 0.1% by mass or larger, and may preferably be 0.6% by mass or smaller, 0.5% by mass or smaller, or 0.4% by mas or smaller. Any increase of the viscosity of the slurry during the fabrication of the electrode tends to be able to be reduced by the fact that the content of lithium hydroxide in the positive electrode active material is in the above ranges. In the case where the positive electrode active material includes lithium carbonate, the content of lithium carbonate may be, for example, 0.01% by mass or larger and 0.8% by mass or smaller, may preferably be 0.01% by mass or larger, 0.05% by mass or larger, or 0.1% by mass or larger, and may preferably be 0.5% by mass or smaller, 0.3% by mass or smaller, or 0.25% by mas or smaller. Generation of any gas during the charging and the discharging tends to be able to be reduced by the fact that the content of lithium carbonate in the positive electrode active material is in the above ranges. The content of the alkaline component such as lithium hydroxide or lithium carbonate may be measured using a neutralizing titration method described later.

A non-aqueous electrolyte secondary battery having an excellent output power property in the low-SOC may be assembled by applying the positive electrode active material is applied to the positive electrode of the non-aqueous electrolyte secondary battery. The positive electrode active material may constitute a positive electrode by being included in a positive electrode active material layer to be disposed on a current collector. The present invention therefore encompasses an electrode for a non-aqueous electrolyte secondary battery that includes the positive electrode active material, and a non-aqueous electrolyte secondary battery including the electrode.

### Electrode for Non-Aqueous Electrolyte Secondary Battery

The electrode for a non-aqueous electrolyte secondary battery includes a current collector, and a positive electrode active material layer that is disposed on the current collector and that includes the above positive electrode active material or a positive electrode active material produced using the above production method. The non-aqueous electrolyte secondary battery including the above electrode may achieve an excellent output power property in the low-SOC.

The density of the positive electrode active material layer may be, for example, 2.6 g/cm³ or larger and 3.9 g/cm³ or smaller, and is preferably 2.8 g/cm³ or larger, and 3.8 g/cm³ or smaller, more preferably 3.1 g/cm³ or larger and 3.7 g/cm³ or smaller, and further preferably 3.2 g/cm³ or larger and 3.6 g/cm³ or smaller. The density of the active material layer is calculated by dividing the mass of the active material layer by the volume of the active material layer. The density of the active material layer may be adjusted by applying an electrode composition described later onto the current collector and thereafter pressuring these.

Examples of the material of the current collector include, for example, aluminum, nickel, and stainless steel. The positive electrode active material layer can be formed by applying, onto the current collector, an electrode composition obtained by mixing the positive electrode active material, a conductive material, a binder, and the like with a solvent, and applying thereto a drying process, a pressuring process, and the like. Examples of the conductive material include, for example, natural black lead, an artificial black lead, and acetylene black. Examples of the binder include, for example, polyvinylidene fluoride, polytetrafluoroethylene, and a polyamide acrylic resin. Examples of the solvent include N-methyl-2-pyrolidone (NMP), and the like.

### Non-Aqueous Electrolyte Secondary Battery

The non-aqueous electrolyte secondary battery includes the electrode for a non-aqueous electrolyte secondary battery. The non-aqueous electrolyte secondary battery includes a negative electrode for the non-aqueous electrolyte secondary battery, a non-aqueous electrolyte, a separator, and the like, in addition to the electrode for the non-aqueous electrolyte secondary battery, For the negative electrode, the non-aqueous electrolyte, the separator, and the like in the non-aqueous electrolyte secondary battery, those for the non-aqueous electrolyte secondary battery can be used as necessary, that are described in, for example, JP2002-075367A, JP2011-146390A, JP2006-12433A (these are incorporated herein by reference in their entirety of the disclosed content), and the like.

### EXAMPLES

The present invention will be described below in detail with reference to Examples while the present invention is not limited to these Examples. The value with which the volume integration value from the small particle diameter side in the volume distribution obtained using a laser scattering method is 50% was used as the volume average particle diameter (D₅₀). For example, the volume average particle diameter was measured using a laser diffraction particle size distribution measuring apparatus (MALVERN Instruments Inc., MASTERSIZER 3000). The specific surface area was measured using a BET specific surface area measuring apparatus (manufactured by Moun-Tech Co., Ltd., Macsorb) and using a gaseous adsorption method (a single point method) that used a nitrogen gas. The composition was measured using an inductively coupled plasma atomic emission spectroscopy apparatus (ICP-AES; manufactured by Perkin-Elmer Corp.). The disorder of the nickel element (Ni-dis) was determined using an X-ray diffraction method. An X-ray diffraction spectrum (with a tube current of 200 mA and a tube voltage of 45 kV).was measured using a CuKα radiation, and structure optimization was performed using the Rietveld analysis using Rietan 2000 software based on the obtained X-ray diffraction spectrum. The percentage of d calculated as the result of the structure optimization was taken as the value of the disorder of the nickel element. The content of the alkaline component was measured using the following neutralizing titration method.

### Neutralizing Titration Method

10 g of powder of the positive electrode active material and 50 ml of pure water were put in a 100-ml beaker and were stirred for 1 hour at the room temperature. After the stirring, the powder of the positive electrode active material was removed by filtering. 30 ml of pure water was added to 20 ml of the remaining filtrate to make 50 ml as the overall amount of a solution. Sulfuric acid at 0.025 mole/L was caused to fall in drops into the solution to measure pH of the filtrate using a pH meter. Representing the titer used up to the first titration point as X ml and the titer used up to the second titration point as Y ml, the concentrations of lithium carbonate and lithium hydroxide remaining in the positive electrode active material powder were calculated using the following calculation formula.

Concentration of Lithium Carbonate (% by mass)={2×0.025×(Y−X)/1,000}×{73.9/(10×20/50)}×100

Concentration of Lithium Hydroxide (% by mass)={2×0.025×(2X−Y)/1,000}×{23.9/(10×20/50)}×100

### Example 1

### Providing Step

Composite oxide particles whose secondary particles had the volume average particle diameter of 15 μm and that had a composition in which Ni, Co, and Mn were Ni:Co:Mn=96:2:2 were obtained using a co-precipitation technique. The obtained composite oxide particles, lithium hydroxide, and aluminum hydroxide were mixt with each other to have molar ratios of Li:(Ni+Co+Mn):Al=1.10:0.98:0.02 to obtain a raw material mixture. Heat treatment was applied to the obtained raw material mixture at 700° C. for 5 hours in the atmospheric air. After the heat treatment, a dispersion process was applied to the raw material mixture to obtain a lithium transition metal composite oxide having a composition in which Ni, Co, Mn, and Al were Ni:Co:Mn:Al=0.94:0.02:0.02:0.02.

### First Adhesion Step

Cobalt oxide was added, to the obtained lithium transition metal composite oxide, at the rate of 2.0 mole % to the total number of moles of the metals other than lithium in the obtained lithium transition metal composite oxide, and these materials were mixed with each other in a mixer to thereby obtain a cobalt adhering material. Heat treatment was thereafter applied to the cobalt adhering material at 650° C. for 5 hours in an oxygen atmosphere (at the oxygen concentration of 40 volume %). A dispersion process was performed for the obtained heat treated material in a resin ball mill and a dry sieve was applied to the dispersion processed material to obtain a lithium transition metal composite oxide having an adhering material that included cobalt, on the surface thereof (second particles).

### Liquid Medium Processing Step

The obtained second particles were added to a sodium sulfate water solution that was prepared to have the sodium ion concentration of 0.422 mole/L to produce a slurry having a solid content concentration of 45% by mass. The solid content concentration was determined by “the mass of the second particles/(the mass of the second particles+the mass of the cleaning fluid)”. The slurry was stirred for 30 minutes and was thereafter dewatered using a funnel to be separated as a cake. The separated cake was dried at 150° C. for 10 hours to obtain a liquid medium processed material as washed particles. The liquid medium processed material was solved in an inorganic acid a chemical analysis was thereafter performed therefor using an ICP atomic emission spectroscopy, and the composition thereof was Li_{1.03}Ni_{0.92}Co_{0.04}Mn_{0.02}Al_{0.02}O₂.

### Second Adhesion Step

Orthoboric acid was added, to the liquid medium processed material obtained above, in an amount to be 0.1 mole % as a ratio of the number of moles of the boron element to the total number of moles of the metals other than lithium in the lithium transition metal composite oxide included in the liquid medium processed material obtained above, to be mixed with each other and stirred, to obtain a boron adhering material.

Heat treatment was applied to the obtained boron adhering material at 350° C. for 10 hours in the atmospheric air to thereby obtain a positive electrode active material that included the aimed lithium transition metal composite oxide as a heat treated material.

The obtained positive electrode active material had the volume average particle diameter of 14.8 μm, the specific surface area of 1.23 m²/g, and the nickel disorder (Ni-dis) of 1.2%. The ratio of the number of moles of lithium to the total number of moles of the metals other than lithium (Li/Me) was 1.03.

### Example 2

A positive electrode active material of Example 2 was obtained in the same manner as that in Example 1 except the fact that orthoboric acid was added in an amount to be 0.3 mole % as the boron element in the second adhesion step.

### Example 3

A positive electrode active material of Example 3 was obtained in the same manner as that in Example 1 except the fact that orthoboric acid was added in an amount to be 1 mole % as the boron element in the second adhesion step.

### Comparative Example 1

A positive electrode active material of Comparative Example 1 was obtained in the same manner as that in Example 3 except the fact that the order of the first adhesion step and the liquid medium processing step was inversed.

### Comparative Example 2

A positive electrode active material of Comparative Example 2 was obtained in the same manner as that in Comparative Example 1 except the fact that the first adhesion step and the second adhesion step were concurrently performed. For example, the lithium transition metal composite oxide obtained in the providing step was added to a sodium sulfate water solution that was prepared to have the concentration of sodium ions of 0.422 mole/L to produce a slurry whose solid component concentration was 45% by mass. The slurry was stirred for 30 minutes and was thereafter dewatered using a funnel to be separated as a cake. The separated cake was dried at 150° C. for 10 hours to obtain a liquid medium processed material as washed particles. The liquid medium processed material was solved in an inorganic acid, a chemical analysis was thereafter performed using an ICP atomic emission spectroscopy, and the composition thereof was Li_{1.03}Ni_{0.94}Co_{0.02}Mn_{0.02}Al_{0.02}O₂. Orthoboric acid was added, to the obtained liquid medium processed material, in an amount to have 2 mole % of cobalt oxide and 1 mole % as the boron element to the total number of moles of the metals other than lithium of the lithium transition metal composite oxide included in the obtained liquid medium processed material to be mixed with each other in a mixer to thereby obtain a cobalt and boron adhering material. Heat treatment was applied to the cobalt and boron adhering material at 650° C. for 5 hours in the atmospheric air. A dispersion process was performed for the obtained heat processed material in a resin ball mill and a dry sieve was applied thereto to obtain a positive electrode active material of Comparative Example 2.

### Comparative Example 3

The lithium transition metal composite oxide obtained in the providing step of Example 1 was taken as a positive electrode active material of Comparative Example 3.

### Evaluation of Battery Properties

For the positive electrode active materials obtained in Examples 1 to 3 and Comparative Examples 1 to 3, evaluation of each of the charge-discharge capacity and the output power property in the low-SOC was performed as below.

### Evaluation Method for Charge-Discharge Capacity

The charge-discharge capacity was evaluated as below for each of the positive electrode active materials obtained in Examples and Comparative Examples.

### Fabrication of Positive Electrode

92 parts by mass of the positive electrode active material, 3 parts by mass of acetylene black, and 5 parts by mass of polyvinylidene fluoride (PVDF) were dispersed in N-methyl-2-pyrolidone (NMP) to be solved therein to prepare a positive electrode slurry. The obtained positive electrode slurry was applied onto a current collector that included an aluminum foil to be dried to thereafter be compression-molded by a roll press machine such that the density of a positive electrode layer was 3.3 g/cm³, to be cut out to have a size of 15 cm², to obtain a positive electrode.

### Production of Non-Aqueous Electrolyte

Ethylene carbonate (EC) and ethylmethyl carbonate (EMC) were mixed with each other at the volume ratios of 3:7 to be taken as a mixed solvent. Lithium hexafluorophosphate (LiPF₆) was solved in the obtained mixed solvent to have the concentration of 1 mole/L to obtain a non-aqueous electrolyte.

### Assembly of Battery A for Evaluation

A lead electrode was attached to the positive electrode obtained above to thereafter be dried in vacuum at 110° C. The positive electrode was next wrapped by a separator that included porous polyethylene to be held in a bag-like laminate pack to be put in an argon dry box. In the argon dry box, a metallic Li foil cut out into a predetermined size was pasted to an SUS plate having a lead to obtain a negative electrode. Polar plates for the positive electrode and the negative electrode were disposed to be held in a laminate pack, and the non-aqueous electrolyte obtained above was poured thereinto to be sealed to obtain a non-aqueous electrolyte secondary battery (single electrode cell) of a laminate type as a battery A for evaluation. The following evaluation of the discharge capacity was performed using the obtained battery A for evaluation.

### Aging

Constant-current and constant-voltage charging (with a cut-off current of 0.05C) at a charging voltage of 4.2 V and with a charging current of 0.1 C (1C is a current with which the discharging ends in 1 hour) and constant-current discharging with a discharge cutoff voltage of 2.5 V and a discharging current of 0.1 C were performed for the battery A for evaluation to cause the non-aqueous electrolytic solution to get familiar with the positive electrode and the negative electrode.

### Measurement of Discharge Capacity

Constant-current and constant-voltage charging (with a cutoff current of 0.005 C) was performed at a charging voltage of 4.25 V and with a charging current of 0.1 C, to measure the charging capacity. Constant-current discharging was performed next at the discharge cutoff voltage of 2.5 V and a discharging current of 0.1 C, to measure the discharge capacity. Table 1 shows the charge-discharge capacity and the efficiency that is the rate thereof of each of Examples 1 to 3 and Comparative Examples 1 to 3.

### Evaluation Method for Output Power Property

For each of the positive electrode active materials obtained in Examples and Comparative Examples, the direct current internal resistance (DC-IR.) was measured and the output power property in the low-SOC was thereby evaluated. The measurement was performed as follows.

### Fabrication of Negative Electrode

97.5 parts by mass of artificial graphite, 1.5 parts by mass of carboxymethylcellulose (CMC), and 1.0 part by mass of styrene-butadiene rubber (SBR) were dispersed in water to prepare a negative electrode slurry. The obtained negative electrode slurry was applied onto a copper foil to be dried and compression-molded to obtain a negative electrode.

### Assembly of Battery B for Evaluation

A lead electrode was attached to each of the positive electrode fabricated for the battery A for evaluation and a current collector of the negative electrode fabricated as above, to be thereafter dried in vacuum at 120° C. A separator was next disposed between the positive electrode and the negative electrode, and these were held in a bag-like laminate pack. These were next dried in vacuum at 60° C. to remove water that was adsorbed to each of the members. The non-aqueous electrolytic solution was poured into the laminate bag in an argon atmosphere to be sealed to assemble a battery B for evaluation.

### Measurement of DC-IR in Low-SOC

The battery B for evaluation after the aging was put in an environment at 25° C. to perform therefor measurement of the direct current internal resistance (DC-IR). Constant-current charging was performed to reach an SOC of 20% at the full charge voltage of 4.2 V and the open potential for the SOC of 20% was thereafter measured. Pulsed discharging was thereafter performed for 30 seconds by a current of 0.12 A to measure the voltage “V” obtained 10 seconds later. The direct current internal resistance was calculated based on the difference between the open voltage and the voltage “V” obtained 10 seconds later. Table 1 shows the result of the relative resistance of each of the Examples and Comparative Examples taken when the resistance value of Comparative Example 3 for the SOC of 20% is set to be 1.00.

TABLE 1

| | | | | | Specific | | | | | |
|---|---|---|---|---|---|---|---|---|---|---|
| | | | | | Surface | | Charge | Discharge | | |
| | | LiOH | Li₂CO₃ | D50 | Area | Ni-dis | Capacity | Capacity | Efficiency | Relative |
| | Li/Me | (mass %) | (mass %) | (μm) | (m²/g) | (%) | (mAh/g) | (mAh/g) | (%) | Resistance |
| Example 1 | 1.03 | 0.13 | 0.21 | 14.8 | 1.23 | 1.2 | 235 | 212 | 90 | 0.85 |
| Example 2 | 1.03 | 0.31 | 0.20 | 14.8 | 0.95 | 1.0 | 240 | 218 | 91 | 0.85 |
| Example 3 | 1.05 | 0.49 | 0.22 | 14.8 | 0.48 | 1.1 | 237 | 213 | 90 | 0.85 |
| Comparative | 1.03 | 0.69 | 0.30 | 14.7 | 0.50 | 3.0 | 228 | 199 | 87 | 0.82 |
| Example 1 | | | | | | | | | | |
| Comparative | 1.03 | 0.43 | 0.35 | 15.2 | 0.36 | 2.2 | 234 | 205 | 88 | 1.03 |
| Example 2 | | | | | | | | | | |
| Comparative | 1.12 | 1.12 | 0.90 | 15.0 | 0.30 | 1.1 | 236 | 211 | 89 | 1.00 |
| Example 3 | | | | | | | | | | |

From Table 1, it was confirmed that, in each of Examples 1 to 3, the output power in the low-SOC was improved compared to those in Comparative Examples 2 and 3, and a larger charge-discharge capacity was maintained improving the output power in the low-SOC compared to those in Comparative Example 1.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

Although the present disclosure has been described with reference to several exemplary embodiments, it is to be understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular examples, means, and embodiments, the disclosure may be not intended to be limited to the particulars disclosed; rather the disclosure extends to all functionally equivalent structures, methods, and uses such as are within the scope of the appended claims.

One or more examples or embodiments of the disclosure may be referred to herein, individually and/or collectively, by the term “disclosure” merely for convenience and without intending to voluntarily limit the scope of this application to any particular disclosure or inventive concept. Moreover, although specific examples and embodiments have been illustrated and described herein, it should be appreciated that any subsequent arrangement designed to achieve the same or similar purpose may be substituted for the specific examples or embodiments shown. This disclosure may be intended to cover any and all subsequent adaptations or variations of various examples and embodiments. Combinations of the above examples and embodiments, and other examples and embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure may be not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter shall be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure may be determined by the broadest permissible interpretation of the following claims and their equivalents, and shall not be restricted or limited by the foregoing detailed description.

All publications, patent applications, and technical standards mentioned in this specification are herein incorporated by reference to the same extent as if each individual publication, patent application, or technical standard was specifically and individually indicated to be incorporated by reference.

What is claimed is:

1. A method for producing a positive electrode active material for a non-aqueous electrolyte secondary battery, the method comprising:
preparing first particles each comprising a lithium transition metal composite oxide having a layered structure, the lithium transition metal composite oxide comprising lithium and nickel;
contacting the first particles with a cobalt compound to obtain a cobalt adhering material;
heat-treating the cobalt adhering material at a temperature in a range of 500° C. to 900° C. to obtain second particles;
contacting the second particles with a liquid medium to obtain a liquid medium processed material; and
contacting the liquid medium processed material with a boron compound to obtain a boron adhering material.

2. The method according to claim 1, further comprising
heat-treating the boron adhering material at a temperature in a range of 100° C. to 450° C. to obtain a heat treated material.

3. The method according to claim 1, wherein
the cobalt compound comprises at least one selected from the group consisting of cobalt oxide, cobalt sulfate, cobalt nitrate, cobalt chloride, and cobalt hydroxide.

4. The method according to claim 1, wherein
in the contacting of the first particles with the cobalt compound, a ratio of a number of moles of cobalt atoms in the cobalt compound to a total number of moles of metal atoms other than lithium in the lithium transition metal composite oxide is 0.1 mole % or higher and 5 mole % or lower.

5. The method according to claim 1, wherein
the liquid medium comprises water.

6. The method according to claim 1, wherein
the liquid medium further comprises at least an alkali metal salt selected from the group consisting of a lithium salt, a sodium salt, and a potassium salt.

7. The method according to claim 1, wherein
the boron compound comprises at least one selected from the group consisting of orthoboric acid, lithium tetraborate, ammonium pentaborate, lithium metaborate, and boron oxide.

8. The method according to claim 1, wherein
in the contacting of the liquid medium processed material with the boron compound, a ratio of a number of moles of boron atoms in the boron compound to a total number of moles of metal atoms other than lithium in the lithium transition metal composite oxide is 0.05 mole % or higher and 2 mole % or lower.

9. The method according to claim 1, wherein
the lithium transition metal composite oxide has a composition in which a ratio of a number of moles of nickel to a total number of moles of metal elements other than lithium is 0.6 or greater and smaller than 1.

10. The method according to claim 1, wherein
the lithium transition metal composite oxide further comprises at least one selected from the group consisting of manganese and aluminum, and has a composition in which a ratio of a total number of moles of manganese and/or aluminum to a total number of moles of metal elements other than lithium is 0.02 or greater and smaller than 1.

11. The method according to claim 1, wherein
the lithium transition metal composite oxide has a composition represented by Formula (1),
Li_{q}NiᵣCoₛM¹ₜM²ᵤO_{2+α} (1)
wherein
q, r, s, t, u, and α satisfy 1.0≤q≤1.3, 0.9≤r≤0.96, 0.01≤s≤0.05,
0.02≤t≤0.08, 0≤u≤0.02, r+s+t+u=1, and −0.1≤α≤0.1,
M¹ comprises at least one selected from the group consisting of Mn and Al, and
M² comprises at least one selected from the group consisting of Ca, Zr, Ti, Mg, Ta, Nb, Cr, Mo, W, Fe, Cu, Si, Sn, Bi, Ga, Y, Sm, Er, Ce, Nd, La, Cd, and Lu.
